(19) United States
(12) Patent Application Publication
(10) Pub. No.: US 2013/0262275 A1
(43) Pub. Date: Oct. 3, 2013

(54) System and Method for providing Internet-based vehicle registration and transactions

(71) Applicants: Chris Outwater, Santa Barbara, CA (US); William Gibbens Redmann, Glendale, CA (US)

(72) Inventors: Chris Outwater, Santa Barbara, CA (US); William Gibbens Redmann, Glendale, CA (US)

(21) Appl. No.: 13/622,754

(22) Filed: Sep. 19, 2012

Related U.S. Application Data
(63) Continuation-in-part of application No. 13/216,173, filed on Aug. 23, 2011.
(60) Provisional application No. 61/376,599, filed on Aug. 24, 2010.

(51) Int. Cl. G06Q 20/40

(52) U.S. Cl. CPC G06Q 20/40145
USPC 705/27.1; 705/44

(57) ABSTRACT

A system and method for augmenting location or event or parking access to a process not only for access to parking, but to goods and services based on the mobile customer being tied to a license plate number or group of license plate numbers tied to a credit card, checking account or other payment account. This allows that customer to biometrically authenticate and order goods to be available at a participating event or drive through location based on a biometrically authenticated order and the (known) proximity of the customer to the drive through location.

### CROSS-REFERENCE TO RELATED APPLICATION

This application is a continuation-in-part of application Ser. No. 13/216,173 filed on Aug. 13, 2011. application Ser. No. 13/216,173 claimed the benefit of U.S. Provisional Patent Application No. 61/376,599, filed Aug. 24, 2010. application Ser. Nos. 13/216,173 and 61/376,599 are hereby incorporated by reference herein in their entirety.

### BACKGROUND OF THE INVENTION

1. Field of the Invention

Embodiments of the present invention relate generally to the field of transactions and more particularly to a system and method for providing Internet-based vehicle registration to access goods and services based on an identifier that is typically a license plate number.

2. Background Information

It is known in the art to automatically scan vehicle license plates. Also, automated parking facilities at several locations use this technique to positively identify a vehicle. Current pattern recognition technology can quickly and accurately read most license plates for checking registration and for potential violations. One can register a vehicle at a multi-space pay station so that a license plate is matched to a particular parking spot for a particular duration.

With the advent of biometrics to authenticate access to mobile devices (e.g., the Atrix 4G, a smartphone with a built-in fingerprint scanner, manufactured by Motorola Mobility of Libertyville, Ill., a company since acquired by Google, Inc., of Menlo Park, Calif.) many people around the world will be able to securely access money, goods, and services through applications running on their mobile, wireless communication devices. These devices will be tied to the customer in various ways, including a personal identification number (PIN), which adds a level of security in addition to biometrics. Therefore, security will be enhanced based on the traditional triple security protections of “who you are (as determined by the biometric device), what you have (the smartphone), and what you know (the PIN).” Authentication can be used to pre-register license plates (or other identifications linked to a vehicle, e.g., RFID transponders), not only to reserve access to parking, but for access to many other types of transactions including shopping, banking, shipping, and bill payment.

Toll facilities that communicate with transponders in vehicles are well known (e.g., Chasek et al. in U.S. Pat. No. 4,303,904). Such transponders can supply the toll facility with stored identification codes (e.g., the vehicle ID and/or owner ID. Some (e.g., Chasek) manage a pre-paid balance, while others (e.g., Chaum in U.S. Pat. No. 5,485,520) teach that the transponder issues a cryptographically secure financial instrument (such as an electronic check). Such systems, however, have the drawback that, if such a transponder is lost or stolen, there is difficulty in recovering the value stored therein. Further, requiring the transponder to participate in the transaction represents a behavior that is not reproduced by a vehicle license plate.

Fraser et al. in U.S. Publication 2010/0191584 teach a method for managing parking rights based on receiving a request for issuing a parking right, the request containing both a unique identifier associated with a parking area and a license plate number identifying a vehicle. This prior art method requires a unique parking location identifier to be determined by a driver from signs or decals at parking spaces. No reservation for parking can be made, and after communicating a request, the driver can only park at the one particular location he has identified. It would be advantageous to have a system that would allow a driver to request parking days, weeks or even months ahead, without committing to some exact parking space at the time of the reservation.

As taught in U.S. patent application Ser. No. 13/216,173, of which this application is a continuation-in-part, it is possible to pre-register a license plate or a number of license plates that are tied to an owner (or multiple owners) of a vehicle and a credit account, such as a bank account or credit card account, this allows fast, convenient, reserved access to a restricted location, such as a parking lot, based on License Plate Recognition (LPR). It would be advantageous to provide a transaction process, not only for reserved access to parking, but access to goods and services based on a mobile cell phone user being associated with a license plate number or group of license plate numbers and further associated with a credit card, checking account, other payment account, or membership in a group, such as a discount membership group using discount coupons, for example.

### SUMMARY OF THE INVENTION

The present invention relates to an Internet-based system and method for reserving parking spaces, either general parking, or parking spaces with special attributes, including one or more kinds of location (near a building, in a district, in the city, near to or in view of an event), the nature of parking (on-street or off-street), the time (which days by date like the 12th or which days by name like M-F, which hours, and which months) or features (a space with charging capability for electric vehicles or hybrids, handicapped, or close to exit), based on price, and using a license plate number as a vehicle identification. Generally, the system of the present invention includes a secure remote database, a unique tag for a vehicle such as an authority-issued license plate (typically a state-issued license plate), and various stationary or mobile license plate reading units. The invention allows for a customer to register a single vehicle, or several vehicles, based on license plate(s). The customer can register and pay for both specific and general parking options within a city or even across cooperating cities wishing to share their databases. Payments can be made by credit card, general subscription or by any other payment method or means, including discounts and promotions based on loyalty programs. Enforcement personnel can query the database to see if a particular parked vehicle has a valid (paid) reservation and permission to park in that particular type of space.

The present invention also relates to a transaction process, not only for reserved access to parking, but access to goods and services based on a mobile cell phone user being associated with a license plate number or group of license plate numbers and further associated with a credit card, checking account, group loyalty or discount plan, or other payment method. This allows the person to order goods to be available at a participating event or drive through location.

Where required, the transaction can be an authenticated order, secured by the user giving a PIN, or, where the cell phone is a smartphone with biometric capabilities, that user may be required to authenticate his identify, for example by providing a fingerprint or by voice authentication, which can be validated by the smartphone. Other verifications may be based on the customer's proximity to the location, such as an event, or store, or drive-through restaurant location, at the time the order is placed.

In the plate shopping registration process of the present invention, which can take place online, the account owner can register and correlate his phone numbers, his license plates, credit and other payment accounts. Further, the owner can create a menu of goods and services that are often repeated and that add to the convenience of using the system. The owner could also set up sub-user accounts to authorized particular individuals, such as a relative or trusted associate, or guest, such that the authorized person could take a vehicle with an authorized plate to a plate shopping drive-through and access a location, services, or goods set aside for the account following their selection.

Embodiments of the present invention also find use for unmanned (though perhaps webcam-aided, remotely monitored) hotel/motels, or for unmanned storage access, where a customer drives in and, based on recognition of a license plate, a light on the customer's reserved room illuminates (providing easy identification and access down a long hall, for example). The customer can walk up and complete the access transaction by keying a PIN into a keypad, or by calling a number and saying a phrase or providing some other biometric entry to be compared against an entry in a secure database.

### BRIEF DESCRIPTION OF THE DRAWINGS

Attention is directed to several drawings that illustrate features of the present invention:

FIG. 1 shows a block diagram of an embodiment of the present invention.

FIG. 2 shows an exemplary reservation entry in a database, in accordance with various embodiments.

FIG. 3 shows a flow chart of an embodiment of a reservation process of a method for providing Internet-based universal parking registration, reservation, and other transactions, in accordance with various embodiments.

FIG. 4 shows a flow chart of an embodiment of an enforcement process of a method for providing Internet-based universal parking registration and reservation, in accordance with various embodiments.

FIG. 5 is an exemplary flowchart of a process for providing Internet-based vehicle parking registration and reservation, in accordance with various embodiments.

FIG. 6 is a schematic diagram of a system that includes one or more distinct software modules to be executed on a controller of a system so as to perform a method for providing Internet-based vehicle parking reservation and other transactions, in accordance with various embodiments.

FIG. 7 shows a server in communication with a local computer at a drive-through store.

FIG. 8A shows a portion of an example database schema suitable for the present invention, the portion being for tracking accounts, users, mobile phones, license plates, and payment methods and transactions that relate to them.

FIG. 8B shows a further portion of the example schema, for tracking vendors, products, locations, and offers also related to the transactions.

FIG. 9 shows a possible receipt or authentication message, regarding a particular transaction, which may contain a fingerprint. a set of voice parameters, or other biometric authentication to allow a user to demonstrate that he is an authorized person.

FIG. 10 is an example flowchart for a license plate based transaction process for ordering or reserving and then obtaining products, services, or access accordingly.

Several drawings and illustrations have been presented to further describe embodiments of the invention. The scope of the present invention is not limited to what is shown in the figures.

### DESCRIPTION OF VARIOUS EMBODIMENTS

The present invention relates to a system and method for providing Internet-based universal registration for access and transactions. The system includes generally the owner's unique, registered wireless device, a secure database, a unique vehicle tag such as a state-issued license plate, and one or more license plate readers, either stationary or mobile.

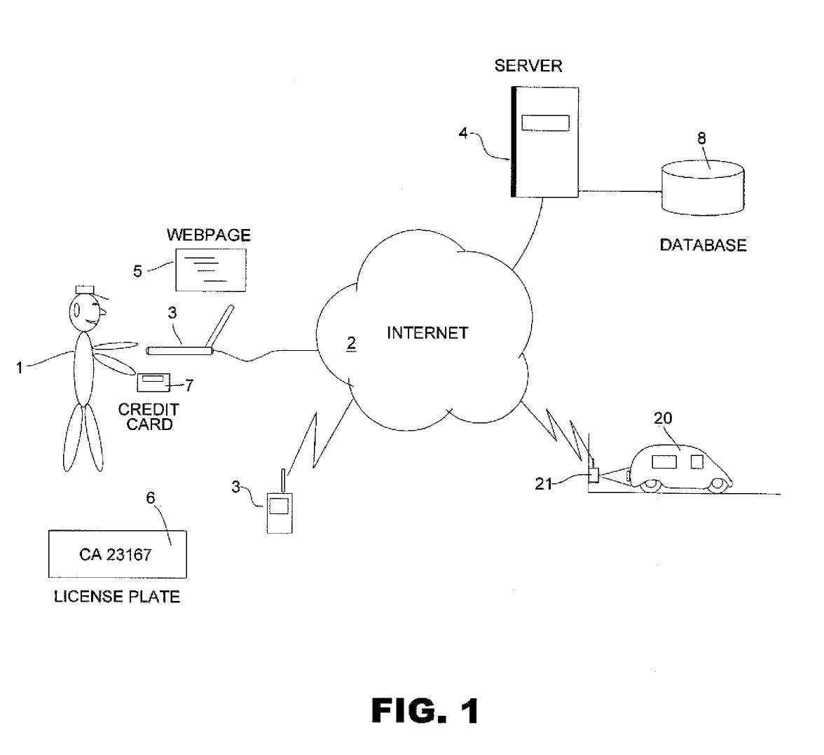

FIG. 1 is a block diagram of a system for providing Internet-based registration of a vehicle license plate and creation of reservations and/or other transactions, in accordance with various embodiments. A customer 1 accesses the Internet 2 with a terminal, smart-phone, or other device 3 (also referred to as user device) to enter information regarding the license plate(s) to be registered and the goods and/or services offered at a target location to be reserved. Alternatively, the customer 1 can give data directly to an attendant at a lot or service location, so that the attendant may enter the information. A server 4 presents a secure webpage 5 with several menus to the user to be displayed, for example, on the user device 3 to accept the information entered by the customer or attendant. The server 4 also accesses a local or remote secure database 8 (also referred to as secure reservation or permit database) to store the information entered and to retrieve information regarding license plates and reservations subsequently. The customer 1 can register one or more license plates 6 during a single session. The webpage 5 can offer a variety of parking options within a city or several cooperating cities for on-street and off-street parking. The web page can also offer goods and services tied to a location or event. The customer can request goods and services at specific locations and specific times based on his license plate and the recognition of his license plate at a corresponding specific location. Authentication can be augmented by communication from the customer's registered wireless device, such as a smartphone 3. Authentication is further augmented if the smartphone is able to make a biometric verification of the customer.

Payment can be made with the account corresponding to a credit card 7, PAYPAL™, an online payment service by PayPal, Inc. of San Jose, Calif., (not shown), or by any other means for credit or debit, including loyalty programs and discount coupons, over the Internet 2. Arrangements can also be made to pay by check. Payment can be one-time, or the customer 1 can start a monthly subscription for unlimited access or parking of a particular type based on time, such as parking for a particular number of days, months or monthly until canceled. The reservation can be based on time, such as parking for one particular day (or particular hours of a particular day), or it can be parking for multiple days during a calendar period (such as weekdays during the month of April). FIG. 1 also shows a vehicle 20 parked in a parking space that is equipped with a license plate scanner 21. While the type of license plate scanner shown in FIG. 1 represents one possibility, any type of scanner or camera, whether stationary or mobile, that can decode or recognize a license plate on a parked or moving vehicle, is within the scope of the present invention.

The server 4 contains at least one processor, and may comprise various memory devices such as read-only memory, random access memory, hard disks and other types of memory devices. The database 8 is generally stored on at least one hard disk or other mass storage devices. The server 4 contains at least one communication module allowing access to the Internet 2 or other networks (such as private networks). The server 4, as well as user devices 3, may communicate via wired or wireless connections.

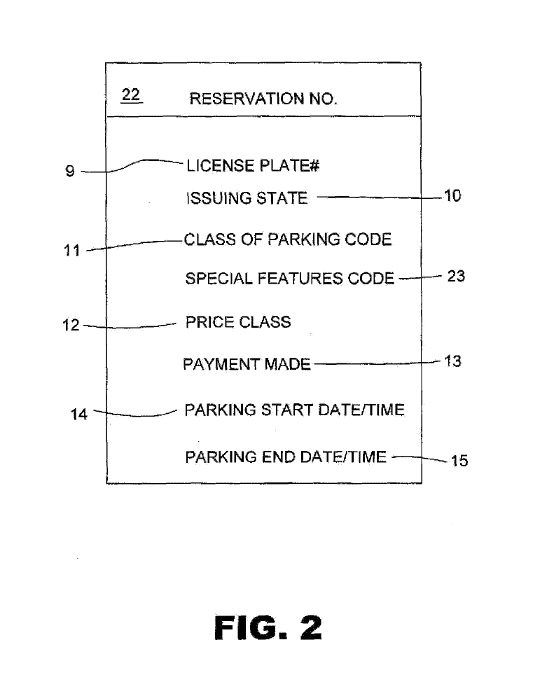

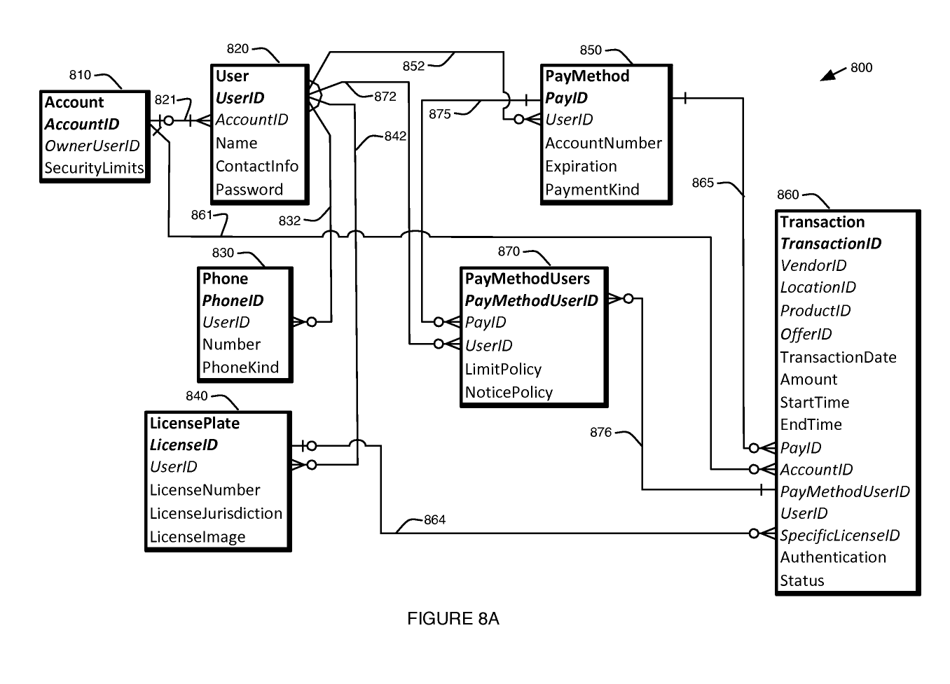

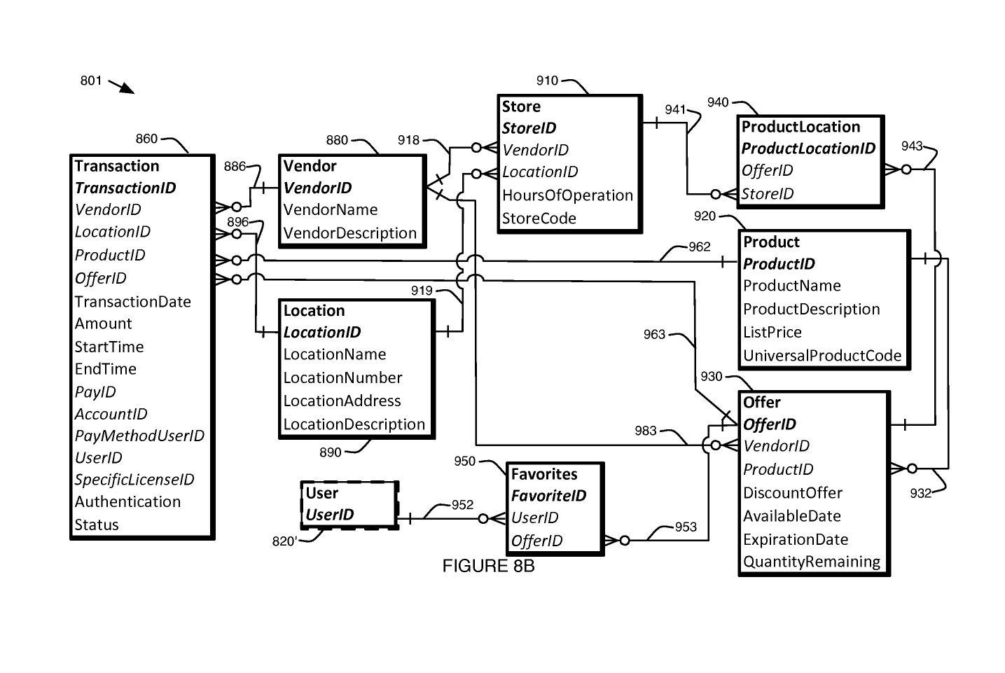

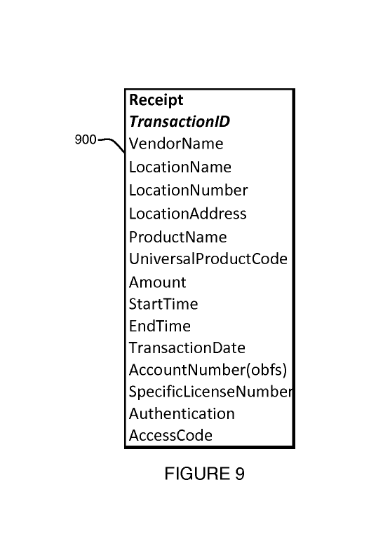

FIG. 2 shows an exemplary entry 22 in the secure reservation or permit database 8, in accordance with various embodiments. One identifier is a state-issued (or other authority-issued) license plate number 9 and the issuing authority (e.g., state, country) 10. The entry 22 generally represents a single reservation. A particular customer can make any number of such reservations. The entry 22, for example, identifies a parking type (i.e., parking privilege or parking class) 11, which may include an attribute (or attributes), such as one or more of the locations (e.g., near a building, in a shopping or entertainment district, or in the city), the nature of parking (e.g., on-street or off-street), the time (i.e., which days by date like the 12th or which days by name like M-F, which hours, and which months), or other attributes, such as an event. Such parking types 11 may be found throughout a municipality. Further the parking type 11 may include a special feature 23 (or features), such as a space with charging capability for electric vehicles or hybrids, handicapped, close to exit, offering a special view of an event, or a location and time based on a loyalty program, a game or a contest, or other special features such as vehicle servicing or cleaning. The entry 22 includes other fields such as price class 12, payment made field 13, parking start date/time 14, and parking end date/time 15. The customer may add another identifier (not shown) such as for a wireless device that could be used to authenticate purchase of goods and services at a location. The database entry 22 shown in FIG. 2 is presented for example only. Also, various entries for the same customer, same vehicle, or any other relationship, such as guest status, can be connected or related as is known in the database art. Any type of queries may be made against these database entries. Another example database structure is shown in FIGS. 8A, 8B, and 9, and is discussed below.

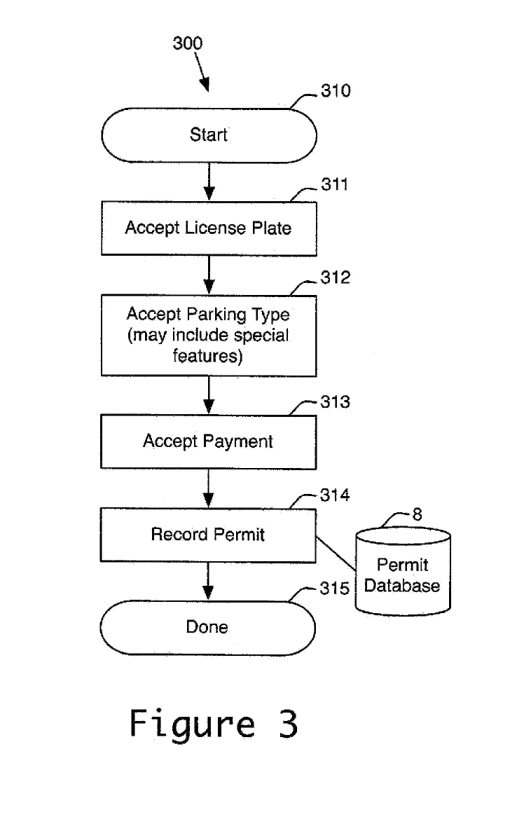

FIG. 3 is a flow chart of an embodiment of a reservation process 300 of a method for providing Internet-based license plate registration, parking reservation, and additional transactions elements for access to goods and services, in accordance with various embodiments. A user begins the process 310 by providing a license plate number 311 as an identifier. Other identifiers can be added at 311, such as a smart phone number and a PIN and a special phrase and a voice pattern, or other biometric values, such as a fingerprint. Next, an access or parking type is entered or determined 312, including any special features or services to be associated with the parking, and payment is accepted 313. Once verification is made that the request is valid, and payment has been made, a reservation or permit is recorded 314 in a secure reservation or permit database 8. Access to goods and services are also recorded, if part of the transaction. After the reservation and request for goods or services are entered in the database 8, the reservation sequence 300 is complete 315.

The webpage 5 presented to the customer 1 during the reservation process 300 generally displays a menu or set of menus. The menus can include multiple levels of parking types based on different attributes, such as one or more of the location (e.g., near a building, in a district, at an event, or in the city), the nature of parking (e.g., on-street or off-street), the time (i.e., which days by date like the 12th or which days by name like M-F, which hours, and which months), or other attributes along with special features such as being part of a loyalty or discount group, or electric vehicle charging, handicapped, close to exit, or other features. Menus can be brought up on demand and can represent a hierarchy or family of callable menus. There can be trees of menus at various levels that are made visible as required. These menus can be shown in order to also offer convenient access to goods and services by virtue of license plate recognition alone, or, when required by policy, augmented by another form of ID, for example, one based on a designated wireless device and verification through communication with a remote secure database.

The present invention can be integrated with present systems during a transition away from pay stations and gated lots. For example, in a pay and display situation, if a vehicle appears to be in violation, the enforcing officer would read the license plate automatically or manually, and then check the database either automatically or manually to see if there is an over-riding registration that nulls the violation. Premium parking near courthouses, civic centers, sports events, etc. can be purchased on the menu. In a gated parking situation, the license plate can be read upon entry or upon exit. The customer can take a ticket, if necessary, like other customers upon entry, but would not have to pay on exit if already pre-paid (or might pay a reduced price in some circumstances, such as loyalty program membership).

With the present invention, parking attendants are not generally needed; however, they can still be used. The same could be said for entry to fast food locations that could receive and order online or a series of orders for a number of days and expect the customer and his license plate to come and appear at that location. Ordering and payment could take place automatically on a pre-ordered basis and can accelerate the entire process. Customers can pre-register and drive in to avoid traffic congestion, or a driver who wishes to instead pay an attendant can do so and immediately get their license plate registered for that event or parking situation. Customers can also build profiles and receive recommendations on what is close to them for easy access, and short lines, or no waiting. Events and shopping locations can be graded on others opinions, general quality, previous experience, part of a loyalty program, proximity and time to receipt of goods and services. In some embodiments, reservations or orders may be placed by a first user on an account, but the presentation of a license plate also associated with the account might be made by a different, second user registered to that account, where the second user concludes the transaction. The system is completely flexible and can be mixed with any and all existing parking, access, and drive-through and payment methods.

Once registered, the user's name, license plate(s), parking menu options, preferred goods and services, loyalty program(s) membership and payment information can be saved in the remote secure reservation or permit database 8. Emails can optionally be sent out when the terms are about to expire. The registration and/or request for parking can be similar to the manner a customer can renew a vehicle registration online. In fact, the registration process can optionally be tied to the vehicle registration process.

Privately owned parking companies currently share license plate information with law enforcement agencies for various enforcement purposes. Such sharing can also be between different cooperating parking authorities. Such sharing may allow customers in a particular area to park, and if they have an electric vehicle, to charge their vehicle, in different cooperating cities. Customers can also buy a single parking registration for more than one vehicle (when a driver sometimes drives one and sometimes drives another). If the customer tries to park both vehicles at the same time under a single reservation or permit, an enforcing officer can be informed of a violation. Depending upon parking enforcement policies, this type of violation may be triggered by both vehicles being detected parking within a certain number of minutes of each other (e.g., within a hour), or a broader period (e.g., on the same day) using the same reservation or permit.

The present invention presents an efficient, Internet-based solution to parking. It allows customers great flexibility in choosing parking access options, and goods and services at chosen locations and it is compatible with current parking facilities such as pay-and-display, gate entry, other types of pay stations, drive-through lanes and the like.

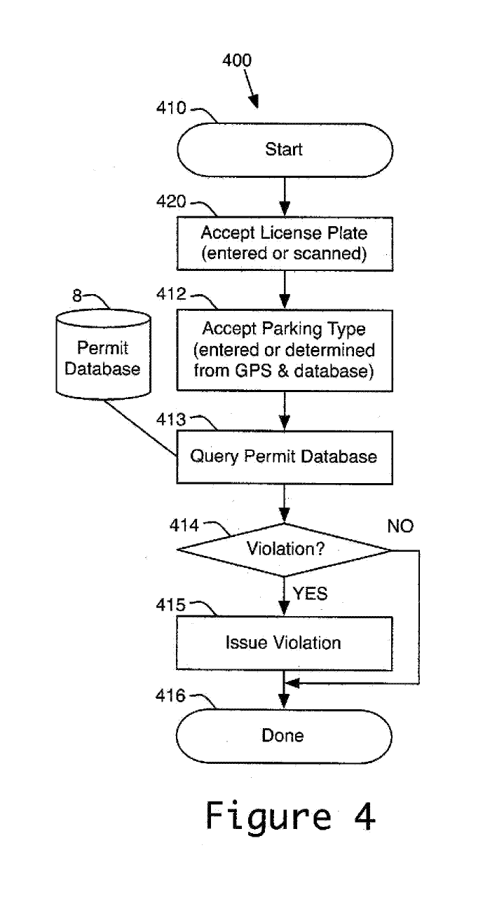

FIG. 4 shows an embodiment of an enforcement process 400 of a method for providing Internet-based universal parking registration and reservation, in accordance with various embodiments. The process is entered 410 by identifying 420 a license plate of a parked vehicle. The license plate number can be entered manually, or it can be automatically scanned. The parking type is determined 412 either by the enforcing authority entering it or by location determined by GPS or other location methods, where the determined location is matched against a database. Once the license number and parking type are ascertained, a query 413 can be made against the secure reservation or permit database 8. A determination 414 can then be made whether the vehicle is legally parked (basing the parking on location, time and parking type, for example). If the vehicle is illegally parked, a violation can be issued 415, or the vehicle can be towed. If the vehicle is legally parked, no action would normally be taken and the process exits 416.

In the field, parking enforcement officers and vehicles can carry remote license plate reading capability. Even officers with no ability to electronically or automatically read the license plate can call a particular telephone number and read the plate number into an automated system, or type the license plate number into a smart-phone application, to get an instant response as to the parking types paid for that license plate. Optionally, enforcing officers can use global positioning system (GPS) enabled equipment to determine exactly where they are and exactly where the vehicle is. This data can then be checked against the secure reservation or permit database 8 to see if a particular vehicle has purchased parking types at that location and time. Enforcement can also be effected by systems of cameras with license plate reading recognition software either in the camera or at a remote computer.

One of the particular parking types can be parking with electric vehicle charging capabilities. This parking type can be accessible through a code offered at the time of parking or by pre-reservation. Enforcement can be based solely on the paid parking types and reading the license plate.

In the unique situation of pay-and-display parking, the enforcing officer can first look to see if the vehicle is displaying a proper ticket. If not, the license plate can be scanned to see if there is a paid reservation. If neither of these is true, a citation can be issued or the vehicle can be towed.

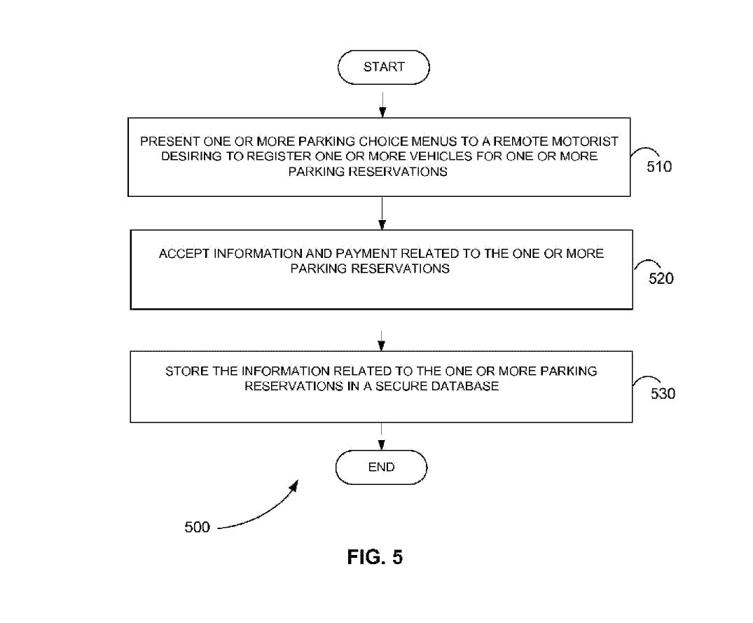

FIG. 5 is an exemplary flowchart showing a method 500 for providing Internet-based vehicle parking registration and reservation.

In step 510 of method 500, one or more parking choice menus are presented to a remote customer desiring to register one or more vehicles for one or more access points and parking reservations. Parking choice menus may allow a customer to select a parking type and special attributes to the access.

In step 520, information and payment related to the one or more access and parking reservations are accepted.

In step 530, the information related to the one or more parking reservations is stored in a secure database.

In various embodiments, method 500 accepts a license plate number of a parked vehicle, accepts a parking type of the parked vehicle, and queries the secure database to determine if the parked vehicle has a valid reservation in the secure database.

In various embodiments, method 500 issues a violation if the parked vehicle does not have a valid reservation in the secure database. In various embodiments, method 500 automatically scans the license plate number of the parked vehicle. In various embodiments, method 500 uses GPS methods to determine the parking type based on a location of the parked vehicle. In various embodiments, method 500 displays the one or more parking choice menus on a user device. In various embodiments, method 500 wirelessly transmits the information related to the one or more parking reservations to the secure database.

The database can send messages to the customer or the customer's agent to confirm purchase of a reservation or goods and service.

In various embodiments, a computer program product includes a non-transitory and tangible computer-readable storage medium whose contents include a program with instructions being executed on a controller of a system so as to perform a method for providing Internet-based vehicle parking registration and reservation. This method is performed by a system that includes one or more distinct software modules.

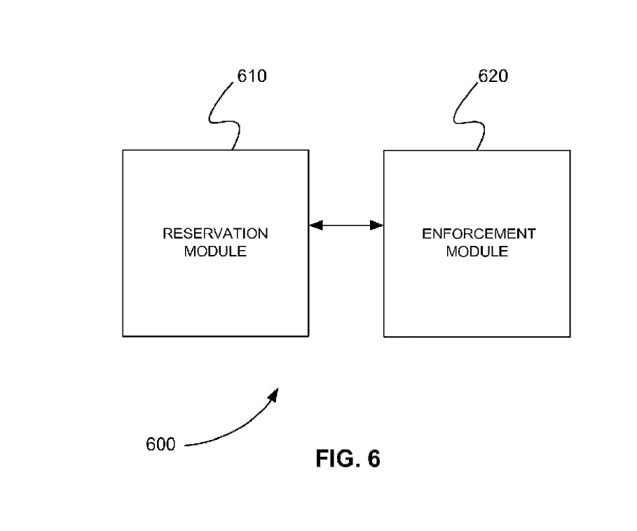

FIG. 6 is a schematic diagram of a system 600 that includes one or more distinct software modules to be executed on a controller of a system so as to perform a method for providing Internet-based universal parking registration and reservation, in accordance with various embodiments. System 600 includes reservation module 610 and enforcement module 620.

Reservation module 610 presents one or more parking choice menus to a remote customer desiring to register one or more vehicles for one or more access and parking reservations and transactions, accepts information tied to the access such as goods and services any loyalty programs and payment methods related to the one or more parking reservations and goods and services requested, and stores the information related to the one or more access points and parking reservations and goods and services in a secure database.

Enforcement module 620 accepts a license plate number of a parked vehicle, accepts a parking type of the parked vehicle, and queries the secure database to determine if the parked vehicle has a valid reservation in the secure database. In some embodiments, enforcement module 620 might be better named the “fulfillment module” 620, for application to providing goods and services or, if not parked and still moving, then merely access on the basis of reservations taken with module 610.

As previously stated, with the advent of biometrics to authenticate access to mobile devices many people around the world will have access to money and goods and services by virtue of their mobile, wireless communication devices (e.g., cell phone/smartphone 3). These devices will be tied to the customer in various ways, including a PIN known to the corresponding user, which adds a level of security additional, but orthogonal, to biometrics. One form of biometrics is fingerprint ID that is already available on some wired and wireless communication devices. Another form of biometrics is voice recognition and a part of that voice process can be a phrase that would be recorded by the owner of the device and would be equivalent to a PIN.

Voice recognition will also become a prominent form of authentication for access, especially as it relates to mobile services, or access to accounts or services tied to driving a vehicle. One of those technologies is NINA™ that is developed by Nuance Communications, Inc. of Burlington, Mass. NINA will be used as a biometric access technology for wireless communication devices. It is possible that the wireless device can initially be accessed by a biometric, such as a fingerprint, but then other programs or products and services can be ordered by authenticated voice and phrases.

Embodiments of the present invention relate to augmenting location or event or parking access to a process not only for access to parking, but to goods and services based on the mobile customer being tied to a license plate number or group of license plate numbers tied to a credit card or checking account or other payment and credit methods including loyalty programs. This novel concept would allow that person to voice authenticate and order goods to be available at a participating event or drive through location based on a verbally authenticated order and the proximity of the customer to the drive-through location. Verbal directions can be added to an existing account set up online or in person and verbal or written commands can specify access and goods and services. Requests and denials and delays can be posted to a user profile for future reference and recommendations. Responses can also be tied to what other people are doing or planning to do, tied to other schedules and calendars, other peoples' schedules and calendars, including friends and associates and other members of a loyalty group. Users can permit, based on policy, other users to be aware of and share their plate parking and plate shopping plans and schedules, for example via social media such a Facebook (Facebook, Inc., Menlo Park, Calif.) or Twitter (Twitter, Inc., San Francisco, Calif.). Friends and associates and loyalty group members can receive awards and incentives for acting with others or encouraging others to access or transact at the same location(s).

In the plate shopping registration process, which can take place online, the wireless device account owner can register and correlate his phone numbers, license plates, credit accounts and may further create a menu of goods and services that are often repeated (e.g., “favorites”) and thus add to a customer's convenience. The owner can also set up sub-user accounts, such as for a relative or trusted associate(s), so that the authorized person(s) could take a vehicle with an authorized plate to a plate shopping drive through and access goods for the account following proper authentication. Finally, the customer could prepay a particular amount if desired, or simply designate a bank account, credit card account, PAYPAL™ account or other credit or debit account, including a loyalty membership and points account that will be used to satisfy transactions at drive-through stores such as convenience stores.

The customer can also ask that an authenticated sub-user call a specific registration number and read or recite a message or phrase from the owner, thus authenticating that sub-user for access to specific goods and services. For example, if a father wanted his daughter to be able to access a certain area with one of the family vehicles, he could register the plate by web, voice, text, or email and direct the service to notify his daughter or expect a call from his daughter's phone whereby she will say a phrase or password which will allow her to also access goods and services, for example, at an event or an airport, or a drive through. The customer can also set limits of time, place, loyalty program participation, and amount to a license plate shopping account.

The voice authenticated wireless customer can be advised of various locations near him, both graphically and/or by voice, via his wireless device. Messages can be written (e.g., web, email, or texted), however, voice messages and directions are often preferred so that the customers can keep their eyes and attention on the road while driving a vehicle.

As is known in the art, the authentication messages, both those originally transmitted to a system server by the customer during registration, and later, those transmitted by a drive-through store can be encrypted for security. Typically, all transactions of this type can be conducted using https: or IP-Sec security standards.

Plate shopping stores can keep things in inventory that are most used and highest volume based on statistical analysis of sales at convenience stores in specific areas. Unless authentication is used to provide higher level of security, e.g. based on biometrics and PIN's, the goods offered at a plate shopping drive through might not include any controlled substances, such as liquor and tobacco. The plate-shopping customer, with authentication, may have access to goods based on biometrics, and the customer will also be able to build a set of plate shopping preferences based on customary needs and convenience and location. For example, some stores may not have the entire inventory, but could have some special inventory based on location and number of customers in the area requesting certain goods. The system can inform the customer where most or all of his requested items can be purchased based on proximity. For example, the customer can be informed that eight out of ten of his requested items can be found within a ⅛ mile radius of his present location at a particular drive through store X, but in order to get the full ten, the customer has to travel ½ mile from his current location to drive through, or other store, Y.

The customer can place limits on how far he will go for a particular number of items and could also be asked to be notified of when items are ready for pick up, or when traffic and wait times are minimal. There can be special order and premium items such as pharmaceuticals. The customer can be notified of specials, loyalty program discounts and offers, and also items that other people have ordered. The customer can search based on proximity, time to delivery, or on best price or on other customers' highest ratings.

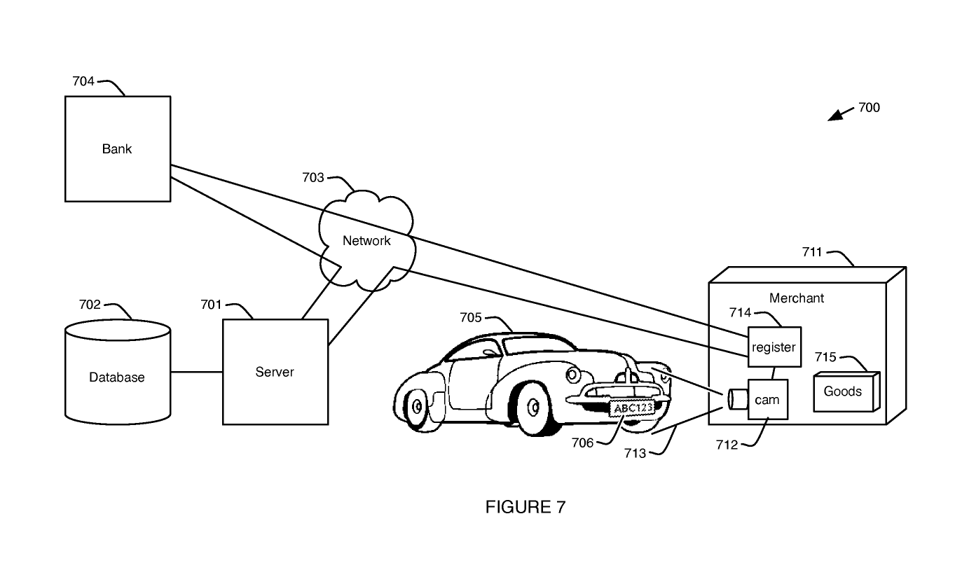

FIG. 7 shows a block diagram of a plate-shopping server 701 and corresponding database 702 in communication with merchant account server 704 (or other electronic payment system) and with a drive-through store 711 through a network 703 (e.g., the Internet). The drive-through store 711 has license plate recognition camera 712 as described, so that when a registered customer in vehicle 705 approaches the drive-through store 711, that particular customer can be identified when license plate 706 enters field-of-view 713 for plate recognition system 712. The register 714, comprising a computer, at the drive-through store 711 communicates an authentication message to the server 701 for recognition. This message can be generated either by register 714, or can be entered into the register 714 from the customer's cellphone. In some embodiments, this verification may also make use of a message link to payment system 704. It should be noted that this transmission can also be completed totally through a hand held telephone either belonging to the customer or the store, where the telephone communication is to either server 710 or payment system 704.

The authentication can be based on time and location and amount authorized, if a purchase of goods and services or cash is desired, as well as requiring biometric data, if needed. An authorization message typically also returns from the server 701 (or in some embodiments 704) to the drive-through store 711 that allows the transaction to complete. After this, the server 701 can transfer the purchase amount from the customer's account to the merchant's account, though in some embodiments the transaction may be pre-paid, in which case the customer's account may already have been debited and in further cases, the merchant's account may already have been credited, that is to say, pre-paid to the merchant rather than pre-paid to an escrow agent (not shown). Loyalty point programs could also be used to pay in part or in full for a transaction.

FIGS. 8A and 8B show a first portion 800 and a second portion 801 of an example database schema suitable for implementing the present invention. The first portion 800 (in FIG. 8A) provides tracking of data corresponding to users and accounts, while the second portion 801 (in FIG. 8B) is primarily directed to products and merchants. A significant element presented in both portions is transaction table 860, which stores records corresponding to the reservations for access or services or orders for goods made using the system.

In these schema diagrams, the convention used is for table names to be presented in bold font, while the key or unique identifiers of a table are given in bold-italic font. Foreign keys are given in italic font. Data elements that are neither record identifiers nor foreign keys are presented in regular fonts.

While the schema shown in FIGS. 8A and 8B is presented as a relational database, this is for clarity and ease of presentation, rather than a suggestion of limitation. Those skilled in the art will recognize that other schemas, and even other data representation and organization paradigms would be usable and successful for implementation of this invention.

In FIG. 8A, the user-centric portion 800 of the database begins with account table 810 in which each account record is identified by a unique identifier AccountID (the key for table 810). User table 820 contains one record for each user of the system, each identified by a unique UserID, a listing the corresponding user's name, contact information, a password or other authentication used when the user logs into the system or the authenticate an transaction. As a good practice, well known to those in the art, such fields would be kept encrypted or in some other embodiments, partitioned to a different portion of the database. Each user record can be associated with an account recorded in table 810, through member-of relationship 821, which allows the records for one or more users to belong to the same account. Each account may also have an owner, noted by the OwnerUserID, which forms an ownership relation (not explicitly shown in crow's foot notation) with a user record in table 820. Each account may be assigned various security limits, previously discussed, such as (by way of example and not limitation) a maximum allowable purchase, or limits as to in what geographical regions or specific locations, and participating locations, are allowed for transactions.

Each user may be associated with zero or more cellular or smart phones, license plates, and payment methods. Phone table 830 includes a record for each phone known to the system, noting a unique PhoneID, which is distinct from the telephone number. Each phone may be classified by a PhoneKind entry, summarizing its capabilities, e.g., whether it is a smartphone, or what kinds of authentication it can provide. If a particular phone is capable of providing cryptographic services, its public key certification (not shown) could be stored here, too. By virtue of the UserID field, the phone-of relationship 832 is formed. In a similar way, license plate table 840 lists all license plates known to the system, wherein each record is uniquely identified by a LicenseID, and the plate number, jurisdiction (i.e., the issuing authority), and in some embodiments a photograph of the plate are stored for use in subsequent license plate recognition activities. Each plate record contains a UserID field to form plate-of relationship 842 with a particular user. Likewise, each user may be associated with payment methods, loyalty groups and points, represented by records in PayMethod table 850. In this table, each record is uniquely identified by the PayID key field, and includes whatever information is necessary for using such methods, for example, the account number, expiration date, and the kind of payment. As above, good practice would be to keep substantial portions of such records encrypted, consistent with well know best practices. The payment-methods-of relationship 852 is provided for each record through the UserID foreign key field.

Since more than one user (represented by a record in table 820) can be associated with a single account (represented by a record in table 810), and each user represented in table 820 may be associated with zero or more phones (in table 830), license plates (in table 840), and payment methods (in table 850), it is possible for a phone, license plate, loyalty group membership, or payment method associated with one user to be used by another user of the same account, provided that is in accordance with an operator's policies.

This allows a father, as a first user (table 820) and owner of a corresponding account (table 810), can provide a payment method (table 850) and license plate (table 840), and may allow use to his daughter, a second user (table 820) also a member of the same account (table 810), who registers and uses her own smartphone in table 830. By virtue of payment-method-of relationship 852, the first user (the father) can cause a record to be created in PayMethodUsers table 870 to denote his permission for his daughter (the second user) to make use of, for example, his credit card or loyalty points. This record notes is-allowed relationship 872 to the daughter's (second user) record in user table 820, and pay-with relationship 875 to the father's credit card record in payment method table 850. The father may also provide specific limits, for example how much she can spend, and/or where, and indicate if and how he should be specially notified regarding each or only certain transactions, or not at all (other than normal credit card billing and loyalty program procedures).

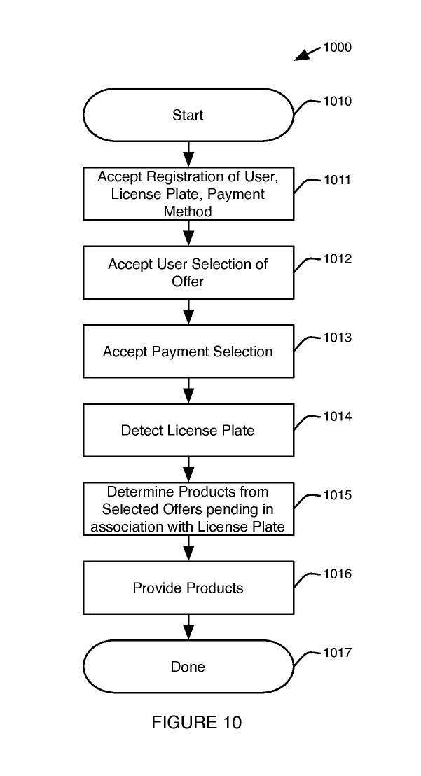

Example transaction table 860 provides a record for each transaction conducted with one embodiment of the invention, in which is stored whatever information is needed users to reserve or order access, goods, or services available from vendors in the system, and ultimately consummate the transaction, as will be discussed below in conjunction with FIG. 10. Each transaction record is uniquely identified by the TransactionID field, and with respect to portion 800 of the database, each transaction is initially associated with one user (ordered-by relationship not explicitly shown in crow's foot notation), one account (shown by on-account relationship 861, and eventually, one payment or credit method (paid-with relation 865), and one license plate (picked-up-by relationship 864). Those skilled in the art may consider adding additional UserID-based fields, for example to indicate which user consummated the transaction (e.g., picked up the goods), or provided authentication for any part of the transaction.

The same transaction table 860 is shown in portion 801 of the example database schema, in FIG. 8B. Each transaction is associated with a record in vendor table 880 by the sold-by relationship 886. Each vendor record has a unique VendorID, and includes the vendor's name and description. There could also be a link for a web site, or customer ratings of the vendor, etc., but these are not included in this example. Each vendor record may be related by has-store relation 918 to a record in store table 910. Each record in store table is uniquely identified by the StoreID field, and includes other information pertaining to the particular store, e.g., their hours of operation, especially for the license plate shopping drive-through. In turn, each store is related by located-at relationship 919 to exactly one location represented by a record in location table 890. Each location record is uniquely identified by the LocationID field, and offers other fields of information such as name, address, unit number (i.e., location number, e.g., for stores located within malls or other shopping centers) loyalty group participation and description of the location.

In some embodiments, for at least some stores within those embodiments, for at least some transactions, during the authentication process, the customer's telephone could be required to scan or transmit a particular QR code (or other barcode or indicia) known in the art. The code value for any particular store is recorded in store table 910 in the StoreCode field. For example, a particular drive-through store could display its own QR code. The authentication process could be initiated by the customer scanning the store's QR code with his telephone. The code would be sent to the server. This would give the server a key that would allow it to access the merchant's details so the transaction could be completed. For a second example, the customer's telephone might be sent a QR code during the registration process. The customer could display this QR code on his telephone, and the drive-though store could read it either with a QR reader or with another telephone. This could be part of the authentication process.

Each vendor maintains a catalog of products they offer. In example database portion 801, products are listed as records in product table 920. The ProductID field uniquely identifies each product record. The product name, description, list price (if applicable), Universal Product Code (UPC), again, where applicable, and other information (e.g., physical size, weight, etc.) may be noted in the record. In this example, ‘products’ are considered to be goods, services, access, as elsewhere discussed, and the product records of table 920 may be adjusted as needed to properly represent a vendor's offerings. A record in offer table 930 represents that a vendor chooses to offer a particular product. The OfferID field uniquely identifies each record. The who-offers relationship 963 associates an offer with a particular vendor, while the offers-what relationship 932 associates an offer with a particular product. The vendor may prescribe a discount for the offer or loyalty program benefits (i.e., a function of the list price). In different embodiments, the final price for the offer may be stored. Other fields may include the date or dates of availability, which may include an expiration date for the offer, and a quantity remaining, for cases where the supply of the product is finite.

As it may not be the case that a vendor with multiple stores offers a particular product at all location, whether or not a product is offered at a particular store is represented by records in ProductLocation table 940, for which each record associates a vendor's offer in table 930 with a store in table 910 by relationships 943 and 941, respectively.

When a transaction is underway, the corresponding record in transaction table 860 tracks from-who relationship 886 (associating the vendor), for-what relationship 962 (associating the product), using-offer relationship 963 (associating the offer), and from-where relationship 896 (associating the location). Other choice may be made instead of these particular relationships, since, for example the vendor and product can be identified from the offer record. However, for some embodiments, efficiencies of access, or the ability to maintain privacy (e.g., not showing the discount or final price) might provide a reason for providing more than one path to the same data.

As previously mentioned, for the convenience of the user, the system may offer storage of favorite or frequently used products, stores, vendors, etc. One example showing an implementation of this is the records in favorites table 950, which associated a user (via relationship 952) with an offer (via 953). Note that in this illustration, user table 820′ is just an abbreviated representation of user table 820 from FIG. 8A, but corresponds to the same table.

While FIGS. 8A and 8B have been described as if they are portion of one common database, this is not a requirement. For example, the user account portion 800 might exist in database 702 with access provided through server 701, while the merchant portion 801 (perhaps in another form) might be hosted on each vendors own server(s) (not shown), for example, their existing web sites. For such embodiments, a protocol between a merchant server and plate-shopping server 701 would provide exchange of sufficient information that a transaction record (replacing those in table 860) could be constructed. Such records can be distributed across the two servers, as needed, with translation, as needed and appropriate (e.g., for which users in portion 800 correspond to which users in portion 801).

Another embodiment may permit a user to create a profile (not shown) of likes, dislikes, interests, group memberships, etc., to allow the system to suggest or recommend certain upcoming events, products, payment methods, locations, etc., to aid users in discovering additional services, products, and places that might be interesting and beneficial to them.

FIG. 9 shows a possible authentication message, which may constitute a receipt for a transaction, containing the vendor name, the location name, number, address, the product name and/or other identification (e.g., UPC), the amount paid, if appropriate a start time and end time (or duration), a date for the transaction (e.g., the consummation date), the payment method account number (which may be partially obfuscated), any loyalty group participation, the specific license number that is expected on the vehicle picking up the product, a notice of what authentication is to be supplied, and an access code (e.g., a combination for opening a locker, or a code to activate a mechanism). The receipt 900, or the like, should be sufficient for a user to access the goods, services, etc., for which the transaction has been generated. A clerk at store 711 can review the receipt, or the receipt can remind the user how and where to complete the transaction. Receipt 900 may be printed from a web site, or email, or be presented by an application on the display of smartphone 3. In some embodiments, the authentication or access code may include machine-readable indicia (e.g., a QR or other barcode).

FIG. 10 shows a flowchart for one example embodiment of a plate shopping process 1000, which begins at 1010. At 1011, a server accepts a registration for a user that includes at least one license plate and at least one payment method. The server may comprise a single server, or may be distributed over multiple servers able to communicate with each other. The registration may be supplied by the user through a web page or smartphone application, or may be entered on behalf of the user for example by an operator. At 1012, the server accepts a selection by the user for an offer for a product (such as a good, service, or access) to be provided by a vendor. At 1013 the server accepts payment or authorization for payment using the payment method, in response to which the server records the selection and payment in association with the registration of the user as a transaction. At 1014, the license plate is detected at a location supported by the vendor and accepted by the server. At 1015 the server determines and identifies to the vendor which product is to be provided by that vendor to fulfill the offer associated with that license plate and that vendor by accessing the transaction. At 1016 the server accepts confirmation from the vendor that the products have been provided to the user associated with the license plate. The plate shopping process concludes at 1017 after the product has been provided for the user and confirmed.

In some embodiments of plate shopping process 1000, the registration at 1011 includes a mobile phone and at 1016 the confirmation from the vendor includes verification that the mobile phone is present, for example by sending a code to mobile phone or by sending a biometric verification from the mobile phone to the server. In some embodiments, the biometric verification may comprise a voice response. In some embodiments, the biometric verification may comprise a fingerprint scanned by the mobile phone.

Several descriptions and illustrations have been presented to aid in understanding various features of the present invention. One with skill in the art will realize that numerous changes and variations are possible without departing from the spirit of the invention. Each of these changes and variations is within the scope of the present invention.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for license plate registered shopping comprising:
a server executing a stored program adapted to register a customer online by correlating a license plate with a payment account, said server also adapted to allow said customer to generate a biometric authentication;
said server adapted to recognize said authentication when the customer with said license plate drives through a drive-through store;
said server adapted to allow said customer, after said authentication is recognized to complete a transaction at said drive-through store.

2. The system of claim 1 wherein said drive-through store has a local computer cooperating with said server, said local computer executing a stored program to present said authorization to the server over a network.

3. The system of claim 2 wherein said local computer is adapted to store a set of preferences for said customer.

4. The system of claim 1 wherein said authentication includes a fingerprint.

5. The system of claim 1 wherein said biometric authentication includes recognition of a voice.

6. The system of claim 1 wherein said drive-through store is located near an event parking location.

7. The system of claim 1 further comprising said server adapted to create an authenticable sub-account for a person other than said customer.

8. A system for license plate registered shopping comprising a sensor at a merchant location for recognizing a license plate, a server remote from said merchant location in network communication with said sensor, a database accessible to said server, a payment service, said server also in network communication with said payment service, wherein said server executing a stored program is adapted to store a license plate number, an associated biometric authentication and an associated account number from said payment service, and wherein said server is also adapted to receive a license plate number over the network from said merchant location, find said license plate number in said database, also receive an a biometric authentication over the network from said merchant location, compare said biometric authentication received over the network with said stored biometric authentication, and if a match is determined, complete a transaction by instructing said payment service to pay a particular amount from said associated account to said merchant.

9. The system of claim 8 wherein said biometric identification can contain a fingerprint or voice recognition parameters.

10. The system of claim 8 wherein said server is also adapted to register a sub-account user.

11. The system of claim 8 wherein said server is also adapted to store a set of preferences associated with a license plate number.

12. The system of claim 8 wherein said merchant location has a local computer cooperating with said server, said local computer executing a stored program to present said authorization to the server over the network.

13. The system of claim 8 wherein said merchant location is located near an event parking location.

14. A method of recognizing and allowing a customer to shop at a drive-through store comprising:
allowing a customer to register a license plate with a service online;
coupling said license plate to a payment account;
providing said customer with a biometric authentication;
receiving said license plate number as a customer approaches a drive-through store;
recognizing said biometric authentication after the customer enters said drive-through store;
completing a transaction at said drive-through store based on said payment account and said biometric authentication.

15. The method of claim 14 wherein said biometric authentication includes a fingerprint.

16. The method of claim 14 wherein said biometric authentication includes voice recognition of said customer.

17. The method of claim 14 further comprising allow said customer to create a sub-account for a person other than said customer.

18. The method of claim 14 wherein said drive-through store is located near an event parking location.

19. A method of shopping administered by at least one server comprising the steps of:
a) accepting a registration with the at least one server for a first user, the registration comprising at least a license plate and a payment method;
b) accepting a selection by the user with the at least one server for a product;
c) accepting a payment for the product with the at least one server through the payment method;
d) recording the selection and payment with the at least one server in conjunction with the registration as a transaction;
e) accepting with the at least one server, from a vendor, data representative of the license plate;
f) indicating to the vendor, with the at least one server, the product to be provided on the basis of the license plate; and,
g) accepting from the vendor an acknowledgement that the product was provided;
whereby the user is able to shop for and obtain products on the basis of the license plate.

20. The method of claim 19 wherein the acknowledgment from the vendor comprises an authentication of the user.
